(19) United States
(12) Patent Application Publication
(10) Pub. No.: US 2015/0175344 A1
(43) Pub. Date: Jun. 25, 2015

(54) PACKAGING ASSEMBLY AND METHOD OF MANUFACTURING A PACKAGING ASSEMBLY

(71) Applicant: Intercontinental Great Brands LLC, East Hanover, NJ (US)

(72) Inventor: Nicolas Gres, Echenevex (FR)

(21) Appl. No.: 14/414,044

(22) PCT Filed: Jul. 8, 2013
(86) PCT No.: PCT/IB2013/001618

§ 371 Date: Jan. 9, 2015

(30) Foreign Application Priority Data
Jul. 10, 2012 (GB) 1212276.8

(51) Int. Cl. B65D 85/60; B65D 5/66; A23G 4/18; B65D 77/02; B65B 11/48; B65B 43/10

(52) U.S. Cl. CPC B65D 85/60; B65B 11/48; B65B 43/10; A23G 4/18; B65D 77/02; B65D 5/66; A23V 2002/00

(57) ABSTRACT

A packaging assembly (10) includes a carton (12) having opposed rear and front walls and an end wall interconnecting the rear and front walls at one end to define an interior volume. A dispensing opening (26) through which products (106) may be dispensed is defined between the front and rear walls at a second end. A closure (28) is movable between a closed position and a product dispensing position. The assembly includes at least one stack of elongate comestible products (106) which is at least partially enclosed about one end by means of a flexible outer wrapper affixed to the carton. In one embodiment, the wrapper only encases a lower portion of the stack. In an alternative embodiment (FIG. 9), the wrapper fully encases the stack but an opening portion of the wrapper is adhered to closure so as to be removed when the carton is first opened.

### TECHNICAL FIELD

The disclosure relates to packaging for products. The disclosure relates in particular, but not exclusively, to packaging for elongate products and more particularly elongate comestible products including gum sticks.

### BACKGROUND

Gum, including chewing gum, is produced in a variety of forms including, gum sticks, gum slabs, and gum pellets and is packaged in a number of different ways.

In one method of packaging gum sticks, the sticks are first individually wrapped and a number of wrapped sticks are then packaged in stack, one behind another, in a sealed packet formed from a flexible outer overwrap. The outer overwrap is typically made from a material that is impervious to moisture and/or oxygen so as to protect the contents of the package from moisture loss and to extend the shelf life of the package. In order to open the packaging, one end of the outer packet is torn to remove an end of the packet. This allows access to the individually wrapped sticks which can be selectively removed through the open end.

This type of packaging has proved to be popular with consumers and is convenient to manufacture using automated processes. However, a drawback is that once the outer packet has been opened and one or more gum sticks removed, the remaining sticks are not securely retained in the remainder of the packet. This means that the remaining sticks so can fall out of the packet, especially when the packet is left in a person's pocket or bag where it may not remain upright. A further problem is that this type of packaging is most suited for packaging a single stack of gum sticks. Consumers these days often wish to purchase gum in larger quantities than cannot be effectively packaged in a single stack.

As other gum products have been developed, alternative forms of packaging have also been developed. Gum slabs for example are often packaged in a carton formed from a blank of foldable material, such as cardboard or paperboard. The slabs are typically arranged in a side-by-side array in the carton, which may have a reclosable flap or other closure member. Reclosable cartons have the advantage that the remaining products are securely retained in the carton after it has been opened and some of the products removed. Cartons are also advantageous in that they provide a relatively large surface area on which information can be printed, such as logos and other graphic design features, and that they can be dimensioned to package larger quantities of gum. Cartons also appeal to consumers who regard them as being a higher standard of packaging than flexible packets.

Cartons though have drawbacks when used as packaging for elongate products such as gum slabs or gum sticks. Manufacture can be more complex as it can be difficult to position the products correctly within the carton as it is formed. Furthermore, whilst a reclosable carton is good at retaining products after first opening, it is difficult to hold the products in an upright position in the carton once one or more products have been removed. To overcome this problem, a number of solutions have been proposed which include adhering each individual product to the carton or an insert and/or the use of additional elements in the carton to retain the products in their correct alignment. Whilst these solutions are effective, they add to the complexity of the packaging and hence to the cost of manufacture.

There is a need then for alternative packaging arrangements that overcome, or at least mitigate, some or all of the disadvantages of the known packaging arrangements.

### SUMMARY

According to a first aspect of the disclosure, there is provided packaging assembly comprising a carton having opposed rear and front walls and an end wall interconnecting the rear and front walls at one end to define an interior volume, the carton defining an opening between the front and rear walls at a second end opposite from said one end through which products may be dispensed and having a closure member movable between a closed position in which it closes the opening to retain products in the interior volume and a product dispensing position in which products may be dispensed through the opening, the packaging assembly including at least one stack of elongate comestible products located within the interior volume, the products in the at least one stack being positioned one behind another in a direction from the front wall to the rear wall, the at least one stack being at least partially enclosed about one end by means of a flexible outer wrapper, the wrapper being affixed to the carton.

In one embodiment, the wrapper only partially encloses the stack of elongate comestible products, an exposed end region of at least a forward most one of the products in the at least one stack projecting from the wrapper and engageable, at least when the closure is in the product dispensing position, to permit the product to be moved out of the wrapper and the carton.

In an alternative embodiment, the wrapper fully encloses the stack of elongate comestible products, the wrapper having one or more lines of weakness that define an openable dispensing region at one end of the stack, the dispensing region being affixed to the closure so that on first movement of the closure to the product dispensing position, the wrapper is torn along the lines of weakness to expose an end region of at least a forward most one of the products in the at least one stack, said exposed end region being engageable, at least when the closure is in the product dispensing position, to permit the product to be moved out of the wrapper and the carton.

In an embodiment, at least one aperture is be defined in the front wall through which the exposed region of at least a forward most one of the products in the at least one stack can be engaged to move the product out of the wrapper and the carton. The aperture may be perimetrically bounded by the front wall around its entire periphery.

In an embodiment, the front wall is shorter than the rear wall, an exposed region of each of the products in the at least one stack projecting beyond an upper edge of the front wall such that an exposed region of at least a forward most product in the at least one stack is engageable to permit the product to be moved out of the wrapper and the carton when the closure member is in the dispensing position.

The closure member may comprise a flap pivotally connected with the rear wall, the flap extending about an end of the products and overlapping at least part of the front wall when in the closed position, the packaging assembly having a fastening arrangement for releasable securing the flap in the closed position. Where the packaging assembly comprises more than one stack of elongate products and where each wrapper has one or more lines of weakness that define an openable dispensing region at one end of the stack, the carton may have a separate flap or separable flap portion associated with each stack, the wrapper within the openable dispensing region of each stack being affixed to a respective one of the flaps or flap portions.

The closure member may comprise a flip-top lid pivotally connected with the rear wall, the packaging assembly having a fastening arrangement for releasable securing the lid in the closed position. The fastening arrangement may comprise co-operating formations on the lid and the front wall for releasably holding the lid in the closed position. Where there us at least one aperture defined in the front wall through which the exposed region of at least a forward most one of the products in the at least one stack can be engaged to move the product out of the wrapper and the carton, the co-operating formation on the front wall may provided on a part of the front wall located between the aperture and the opening between the front and rear walls through which products may be dispensed.

The packaging assembly may comprise at least two stacks of elongate comestible products arranged side-by-side within the interior volume, each stack of products being partially enclosed by means of a flexible outer wrapper.

The, or each, flexible outer wrapper may be adhered to the carton.

Where each stack elongate comestible products is only partially encased by a flexible wrapper, the, or each, flexible outer wrapper may encase its respective stack of about one end, the other end of the products in the stack projecting beyond the wrapper.

The carton may be formed from a blank of foldable material.

The carton may consist of the rear wall, the front wall, the end wall and the closure member only, the front and rear walls both being affixed to the, or each, flexible outer wrapper. In this embodiment, the sides of the carton are open, there being no side walls. Alternatively, the carton may also comprise a pair of opposed side walls extending between the rear and front walls to define the interior volume.

The elongate comestible products may all individually wrapped and may be are gum sticks.

In accordance with a second aspect of the disclosure, there is provided a method of manufacturing a packaging assembly in accordance with the first aspect of the invention, the method comprising: producing a blank of foldable material for forming the carton, at least partially encasing at least one stack of elongate comestible products in a flexible outer wrapper, positioning the at least one partially encased stack on the blank, affixing the, or each, flexible outer wrapper to the blank, and folding the blank about the at least partially encased stack to form the carton and securing in position.

The step of affixing the, or each, flexible outer wrapper to the blank may be carried out before the carton is fully formed. The step of affixing the, or each, flexible outer wrapper to the blank may be carried out before the blank is folded about the stack to define the interior volume.

The, or each, flexible outer wrapper may be affixed to a first part of the blank before the blank is folded about the stack to define the interior volume and is affixed to a further part of the blank during the process of folding the blank.

According to a third aspect of the disclosure, there is provided packaging assembly comprising a carton having opposed rear and front walls and an end wall interconnecting the rear and front walls at one end to define an interior volume, the carton defining an opening between the front and rear walls at a second end opposite from said one end through which products may be dispensed and having a closure flap projecting from the rear wall and movable between a closed position in which it closes the opening to retain products in the interior volume and a product dispensing position in which products may be dispensed through the opening, the packaging assembly comprising at least one stack of elongate comestible products located within the interior volume, the products in the at least one stack being positioned one behind another in a direction from the front wall to the rear wall, the at least one stack being enclosed by means of a flexible outer wrapper which is affixed to the carton, an openable dispensing region being defined in the wrapper by means of one or more lines of weakness, the wrapper within the openable dispensing region being affixed to the flap in its closed position, the arrangement being configured such that on first movement of the flap to the dispensing position, the wrapper is torn along the lines of weakness with the openable dispensing region of the wrapper remaining attached to the flap so as to expose an end region at least a forward most one of elongate products, said exposed end region being engageable, at least when the flap is in the product dispensing position, to permit the product to be moved out of the wrapper and the carton.

According to a fourth aspect of the disclosure, there is provided a blank for forming a carton for use in a packaging assembly in accordance with either of the first and third aspects of the inventor or the method manufacturing a package assembly in accordance with the second aspect of the invention, the blank comprising an elongate, substantially rectangular sheet of foldable material, the sheet being divided by means of substantially parallel fold lines to define a front wall panel connected by a first fold line to a lower end wall panel, a rear wall panel connected by means of a second fold line to the lower end wall panel and by means of a third fold line to a first foldable flap panel, the first foldable flap panel being connected at a side opposite the rear wall panel with a second foldable flap panel by a fourth fold line.

### BRIEF DESCRIPTION OF THE DRAWINGS

In order that the disclosure may be more clearly understood embodiments thereof will now be described, by way of example only, with reference to the accompanying drawings, of which:

FIG. 1 is a front view of a packaging assembly in accordance with an embodiment of the invention shown in a closed configuration;

FIG. 2 is a view similar to that of FIG. 1 but showing the packaging assembly in an open configuration;

FIG. 3 is a partial view from the front of the packaging assembly of FIGS. 1 and 2, illustrating removal of a product from the packaging assembly;

FIG. 4 is a front view of the packaging assembly of FIGS. 1 to 3, showing the assembly in a partly assembled condition;

FIG. 5 is a plan view of a foldable blank for a carton forming part of the packaging assembly of FIGS. 1 to 4;

FIG. 6 is a front view of a packaging assembly in accordance with a further embodiment of the invention shown in an open configuration;

FIG. 7 is a side view of the packaging assembly of FIG. 6 showing the package assembly in a closed configuration;

FIG. 8 is a front view of a packaging assembly in accordance with a still further embodiment of the invention shown in a partially assembled condition prior to a closure flap being folded about an end of the products in the assembly;

FIG. 9 is a side view of the packaging assembly of FIG. 8 showing the package assembly in a closed configuration;

FIG. 10 is a front view of the packaging assembly of FIGS. 8 and 9 showing the assembly after first opening; and

FIG. 11 is a plan view of a foldable blank for a carton forming part of the packaging assembly of FIGS. 6 & 7.

### DETAILED DESCRIPTION

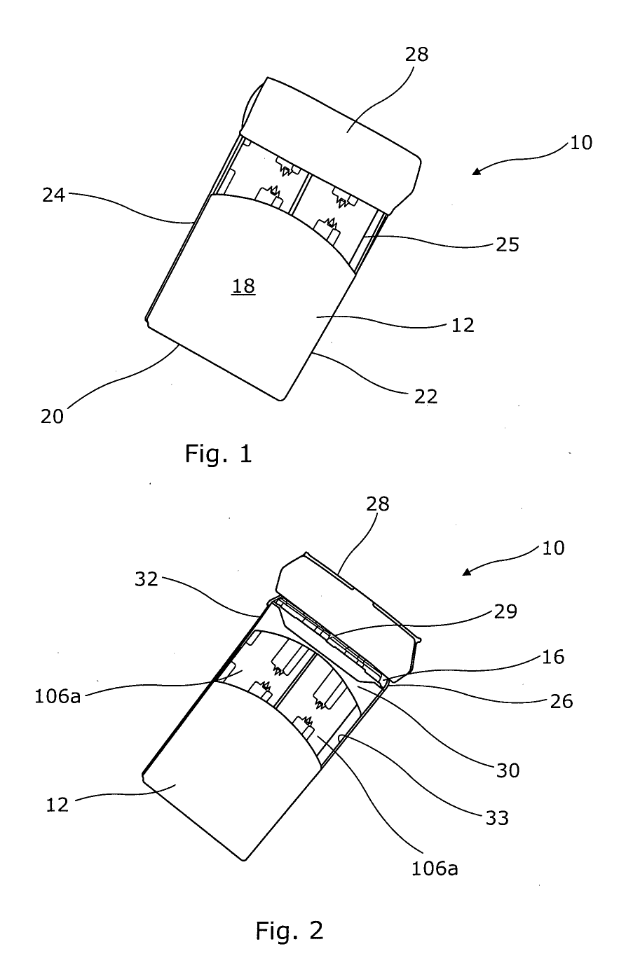

A first embodiment of a packaging assembly 10 in accordance with the disclosure is illustrated in FIGS. 1 to 5.

The package assembly comprises a carton 12 formed from a blank 14 of foldable material such as cardboard, paperboard and the like. The carton has a rear wall 16, an opposed front wall 18, an end wall 20 interconnecting the rear and front walls at one end, and opposed side walls 22, 24 interconnecting the rear and front walls 16, 18 along opposing sides to define an interior volume 25. A dispensing opening 26 is defined between the rear and front walls 16, 18 at the end opposite from the end wall 20. The carton includes a reclosable closure member in the form of a flip-top lid 28 pivotally attached to the rear wall 16 at the end opposite from the end wall 20 by means of a hinge 29.

For convenience, the end of the carton 12 comprising the end wall 20 will be referred to as a lower end and the end at which the lid 28 is located will be referred to as an upper end, as this is the orientation in which the carton it is shown in the drawings and in which it will often be held when a user dispenses products. Similar terminology will also be used in relation to the packaging assembly as a whole. However, it should be understood that the packaging dispenser 10 and carton 12 can be held and used in a number of different orientations. The use of directional terms such as upper, lower, front and rear in the description and claims should be understood in this context.

The lid 28 is movable from a closed position as shown in FIG. 1, in which a forward edge of the lid locates over the front wall 18 to close the dispensing opening 26, and a dispensing position as shown in FIG. 2, in which the lid is pivoted backwardly to allow products to be dispensed through the dispensing opening 26. A tab 30 projects downwardly and outwardly from an upper edge 32 of the front wall 18 for engagement with formations on an inner surface of the lid to releasably hold the lid in the closed position. An aperture 33 is provided in the front wall 18 close to the dispensing opening 26 to enable a user to engage products to move them through the dispensing opening as will be discussed in more detail below.

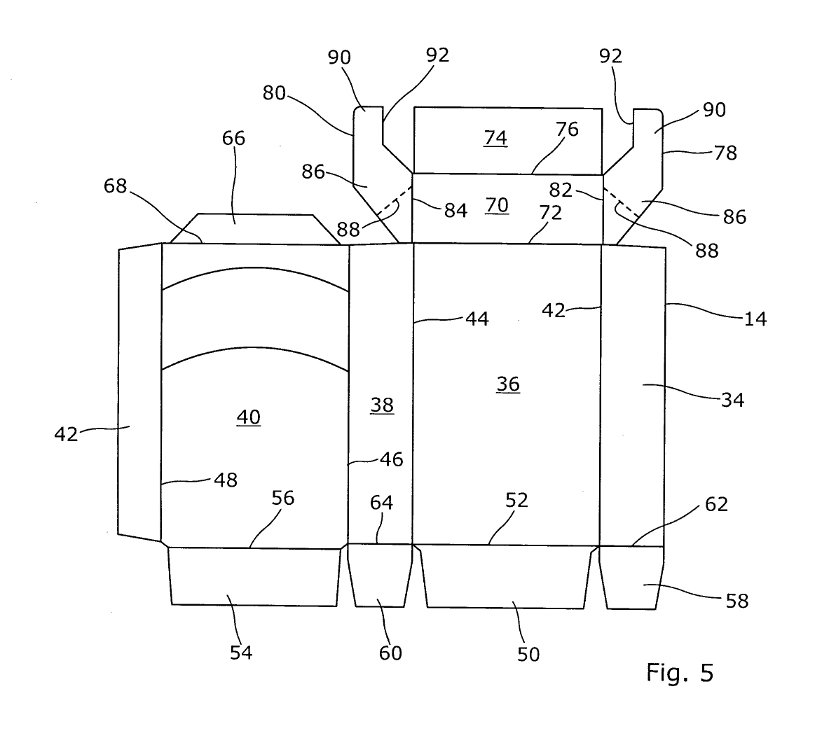

A blank of foldable material 14 for forming the carton is shown in FIG. 5. The blank can be made of any suitable material such as cardboard, paperboard or the like. The material may be printed on to provide information and to include trademarks, logos and other graphic design features.

The blank 14 comprises from right to left, a first side wall panel 34, a rear wall panel 36, a second side wall panel 38, a front wall panel 40, and a glue flap 42, the panels and flap being separated by respective fold lines 42, 44, 46, 48. The blank 14 is folded about the fold lines 42, 44, 46, 48 to produce the front 16, rear 18 and side walls 22, 24 of the carton. The glue flap 42 is affixed to an inner surface of the first side wall panel 34 to hold the blank in its folded condition. The end wall 20 of the carton is formed in a known manner by means of a first end wall flap 50 separated from a lower end of the rear wall panel 36 by a fold line 52, a second end wall flap 54 separated from a lower end of the front wall panel 40 by a fold line 56 and by a pair of end wall tabs 58, 60 respectively separated from the lower ends of the side wall panels 34, 38 by respective fold lines 62, 64. A flap 66 for forming the tab 30 is attached to an upper end of the front wall panel 40 by means of a fold line 68.

To produce the flip-top lid 28, the blank 14 has a first lid panel 70 connected to an upper edge of the rear wall panel 36 by a fold line 72 and a second lid panel 74 connected to the first lid panel 70 by a further fold line 76. The first and second lid panels 70, 74 are folded relative to one another about fold line 76 to form a triangular shape similar to a pitched roof. The sides of the lid are formed by means of tabs 78, 80 foldably attached to opposite sides of the first lid panel 70 by fold lines 82, 84. Each tab is separated into two portions: a first portion 86 which forms a side wall of the lid and which is folded about diagonal line 88, and a second portion 90 which is attached to the inner surface of the second lid panel 74 to hold the two lid panels in their folded configuration. The second portion 90 of each tab is shaped to define an abutment edge 92 which co-operates with the tab 30 to hold the lid 28 in the closed position. In other embodiments, the diagonal fold line 88 can be omitted.

Portions of the blank can be bonded together after folding to form the completed carton using any suitable adhesive which may be pre-applied to the blank prior to folding or applied as part of the process of folding the blank to form the carton.

The rear, front, side, and end walls 16, 18, 22, 24, 20 of the carton define an interior volume 25 in which two stacks of gum sticks 102, 104 are contained in side-by-side relation. Each stack 102, 104 comprises a plurality of individually wrapped gum sticks 106 positioned one behind another in a direction from the front wall 18 to rear wall 16 of the carton. The number of wrapped sticks 106 in each stack is not an essential element and each stack could typically contain in the range of five to twelve sticks, for example. However, there could be more or fewer sticks than this in each stack if desired. The individual gum sticks 106 can be wrapped in a wrapper of any suitable material including composite or laminated materials. For example, each gum stick 106 may be wrapped in a wrapper comprising a metallic foil outer layer and a paper or tissue inner layer. Wrappers made of or comprising polymeric materials can also be used to wrap each individual gum stick 106.

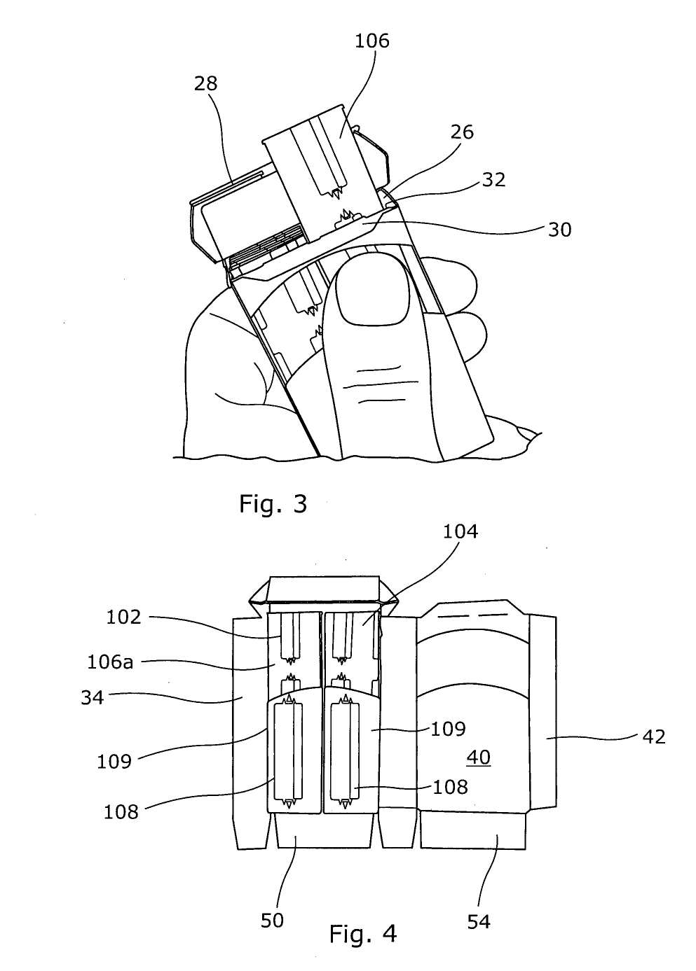

Each stack 102, 104 of individually wrapped gum sticks 106 is partially encased in an outer wrapper of flexible material 108 to form a packet assembly 109, with at least one end region 106a of the gum sticks projecting from the outer wrapper 108. The region or regions 106a of each gum stick 106 which are not encased in the outer wrapper will be referred to as exposed regions. In the present embodiment, the outer wrapper 108 encases one end of the stack of gum sticks, so that the other end projects out of the wrapper. The packet assemblies 109 are positioned within the carton so that the ends with the outer wrapper 108 are located at the lower end of the carton adjacent end wall 20, with the exposed end regions of the sticks projecting towards the upper end of the carton. This allows the gum sticks 106 to be slid out of the outer wrapper 108 and out through the dispensing aperture 26 when the lid 28 is in the dispensing position, as illustrated in FIG. 3.

To assist a consumer in removing a gum stick, the aperture 33 in the front wall 18 is aligned with the exposed end regions 106a of the sticks 106. This enables a consumer to engage an exposed region of the forward most gum stick 106 in each stack, using for example their thumb, and slide the stick out of the outer wrapper 108 and out through the dispensing opening 26 when the lid 28 is in the open, dispensing position. After dispensing one or more gum sticks, the lid 28 can be moved to the closed position where it is held shut by engagement of the tab 30 with the abutment edges 92 of the side tabs in the lid 28. This securely retains the remaining gum sticks in the carton. Furthermore, because the gum sticks are partially enclosed in the outer wrapper 108, they are securely held in an upright position within the carton and will not fall sideways even after several have been removed from each stack or when one of the stacks is emptied. The outer wrapper 108 of each packet assembly 109 is affixed to the carton to hold it in position by means of an adhesive or by any other suitable means such as welding. Any suitable adhesive can be used including a cold seal adhesive. The outer wrapper 108 can be made from any suitable material including composite or laminated materials. For example, the outer wrapper can be made of materials such as: polymeric materials, metallic foils, paper and the like, or combinations thereof. The outer wrapper 108 may be printed on, as can the individual wrappers for each gum stick. At least some of the individual gum sticks 106, which may be individually wrapped, may be releasably bonded to the inside of the outer wrapper 108 and/or to each other to hold them in place inside the outer wrapper. Any suitable method of bonding can be used such as an adhesive, which may be a cold seal adhesive. The bond strength should be sufficient to hold the sticks 106 in place against accidental dislodgement but not sufficiently strong as to prevent ready dispensing by a consumer.

A method of manufacturing the package assembly 10 will now be described. The gum sticks 106 are first individually wrapped and then arranged in a stack 102, 104 and the outer wrapper 108 applied about one end of the stack to form a packet assembly 109. Two packet assemblies 109 are then positioned on a blank 14 side-by-side prior to the blank being folded to define the interior volume 25. As illustrated in FIG. 4, the packet assemblies can conveniently be positioned and adhered to the rear wall panel 36 of the blank 14. The blank 14 is then folded about the packet assemblies to form the finished carton in the usual manner. In addition to affixing the outer wrappers 108 of the packet assemblies 109 to the rear wall panel 36 of the blank, the outer wrappers could also be affixed to the front wall panel 40 and/or to one or more of the side wall panels 34, 38 as the blank is folded for additional security. Typically, the front and side wall panels 34, 38, 40 will be initially folded about the packet assemblies 109 and secured in position using the glue tab 42. The end wall 20 is then formed by folding the end wall flaps 50, 54 and tabs, 58, 60 and securing in position using an adhesive. As illustrated in FIG. 4, the lid 28 could be formed prior to the remainder of the blank being folded about the packet assemblies and indeed even prior to packet assemblies being located on the blank 14. However, this is not essential and the lid 28 could be formed after the blank has been folded about the packet assemblies or at the same time. Those skilled in the art will appreciate that the precise order in which certain steps are carried out can be varied.

The method of manufacture is advantageous as the gum sticks 106 are securely retained in their stacks by the outer wrapper 108 which in turn are held in position on the blank 14 as the blank is formed into a carton. This simplifies the method of manufacture when compared with known arrangements for forming a carton containing an array of side-by-side gum slabs for example. The outer wrapper 108 is positioned about the stack of gum sticks 106 to hold them together firmly but not so tightly that a gum stick cannot be slid out of the outer wrapper by a consumer using a reasonable level of force.

The packaging assembly 10 and its method of manufacture offers many of the advantages over both carton type packages and the flexible packet arrangements.

It will be appreciated that various changes could be made to the packaging assembly 10 without departing from the scope thereof. For example, the carton need not have a flip-top lid but could be provided with alternative reclosable closure member. For example, the carton could have a reclosable flap extending from the rear wall and which folds over the top of the products and down over the front wall 18 when in a closed position. An end of the flap could be arranged to engage in a slit in the front wall to hold it in the closed position but any suitable arrangement for holding the flap in the closed position could be used. An advantage of using a flap is that the flap could cover the aperture 33 in the front wall 18 when it is in a closed position.

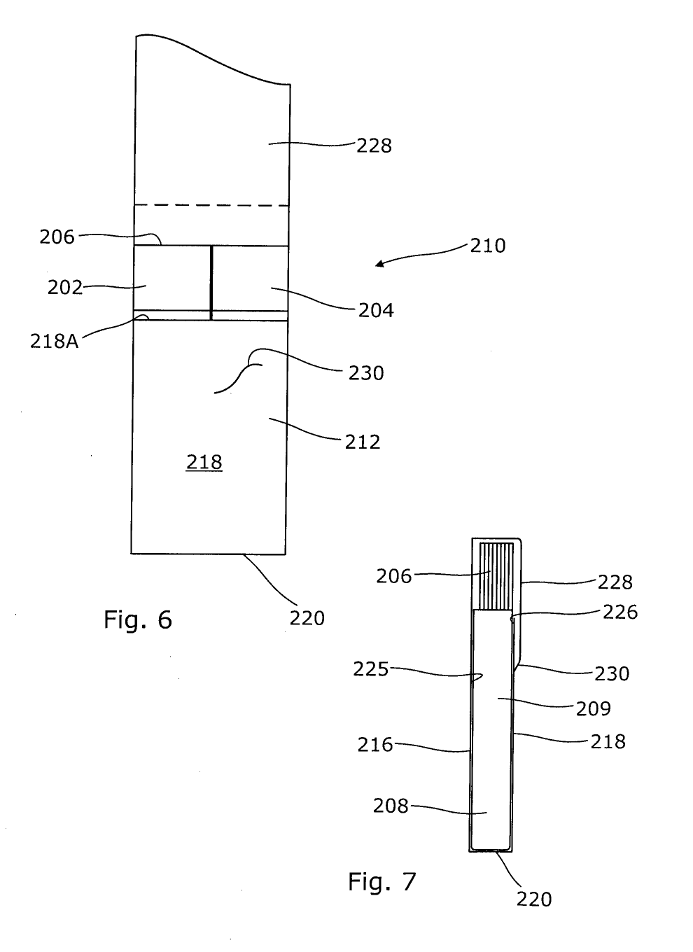

A second embodiment of a packaging assembly 210 will now be described with reference to FIGS. 6 and 7.

The packaging assembly 210 in accordance with the second embodiment has a simplified carton 212 having a rear wall 216, a front wall 218, a lower end wall 220 and a closure member in the form of a foldable flap 228 which extends from an upper end of the rear wall and which in the closed position, as shown in FIG. 7, overlaps part of the front wall 218. A slot 230 is provided in the front wall in which an end of flap can be inserted to hold the flap in the closed position. When initially formed, the flap 228 may be held in a closed position by means of adhesive so that the flap is only inserted in the slot 230 after initial opening to reclose the carton. The carton 212 has no side walls and so can be formed from a simple elongate blank of foldable material (not shown) with suitable fold lines to delineate the rear, front and end walls 216, 218, 220 and the closure flap 228. In this embodiment, the sides of the carton are open thus exposing the sides of the wrapped stacks of gum sticks.

The rear, front and end walls 216, 218, 220 of the carton define an interior volume 225 in which two stacks 202, 204 of elongate individually wrapped gum sticks 206 are held in side-by-side relation. A dispensing opening 226 for the carton is defined between the upper edge 218A of the front wall 218 and the opposed rear wall 216 of the carton. As in the first embodiment, each stack of gum sticks 206 is partially enclosed about a lower end by means of an outer wrapper 208 to form a packet assembly 209. The gum sticks 206 project out of the outer wrapper at an upper end. At least the rear wall 216 and the front wall 218 of the carton are bonded to the outer wrappers 108 of the packet assemblies to hold them in position and to ensure the packet assemblies do not fall out of the carton.

The front wall 218 of the carton is shorter than the rear wall 216 so that the exposed end regions of the gum sticks that project from the outer wrappers 208 project beyond the upper edge 218A of the front wall. When the closure flap 228 is in an open, product dispensing position, as shown in FIG. 6, the exposed regions of at least the forward most gum sticks 206 in each stack can be engaged by a consumer to move the stick out of the outer wrapper 208 and hence out of the carton through the dispensing open 226.

After one or more gum sticks 206 have been dispensed, the flap 228 can be folded over the exposed ends of the gum sticks 206 and inserted in the slot 230 to retain the remaining gum sticks in the carton.

The packaging assembly 210 in accordance with the second embodiment can be manufactured in a similar method to that of the first embodiment. The gum sticks 206 are first individually wrapped and then arranged in a stack 202, 204 and the outer wrapper 208 applied about one end of the stack to form a packet assembly 209. The two packet assemblies 209 are positioned on a blank 214 side-by-side prior to the blank being folded to define the interior volume. Typically, the packet assemblies 209 will be positioned on and adhered to a rear wall panel of the blank and the blank folded about the packet assemblies to form the end and front walls 220, 218. At least the front wall is also adhered to the outer wrappers 208 of the packet assemblies but the end wall may also be adhered for additional security.

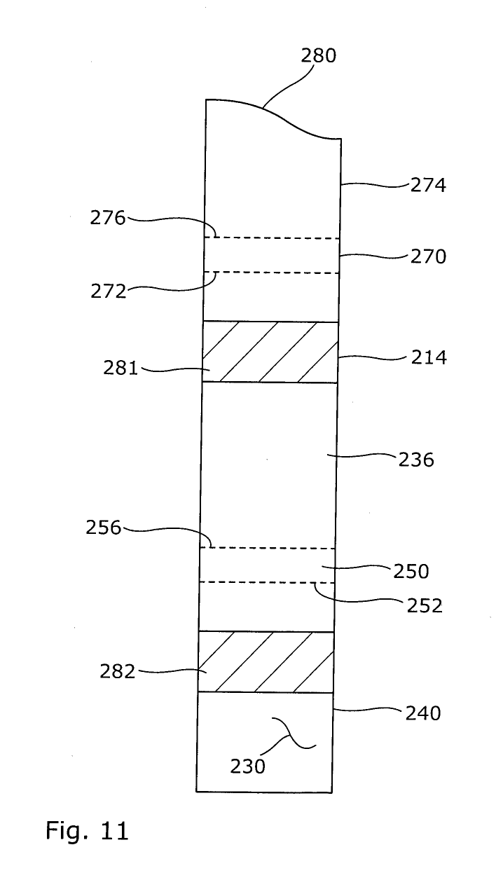

A blank 214 for forming the carton 212 is illustrated in FIG. 11. The blank comprises an elongate, substantially rectangular sheet of foldable material such as cardboard or paperboard or the like. The blank 214 is divided by means of spaced, parallel fold lines 252, 256, 272, 276 to define a front wall panel 240, a lower end wall panel 250, a rear wall panel 236, and panels 270, 274 for forming the foldable flap 228. A slot 230 is provided in the front wall panel and the free end 280 of the flap panel 274 may be profiled to define a tab portion for insertion into the slot. Regions of adhesive 282, 284 may be applied to the inner surfaces rear wall panel 236 and the front wall panel 240 for engagement with the wrapped stacks of gum sticks 2202, 204. A region of adhesive may also be applied to the lower end wall panel. The first flap panel 270 defines an upper end wall when the carton is closed.

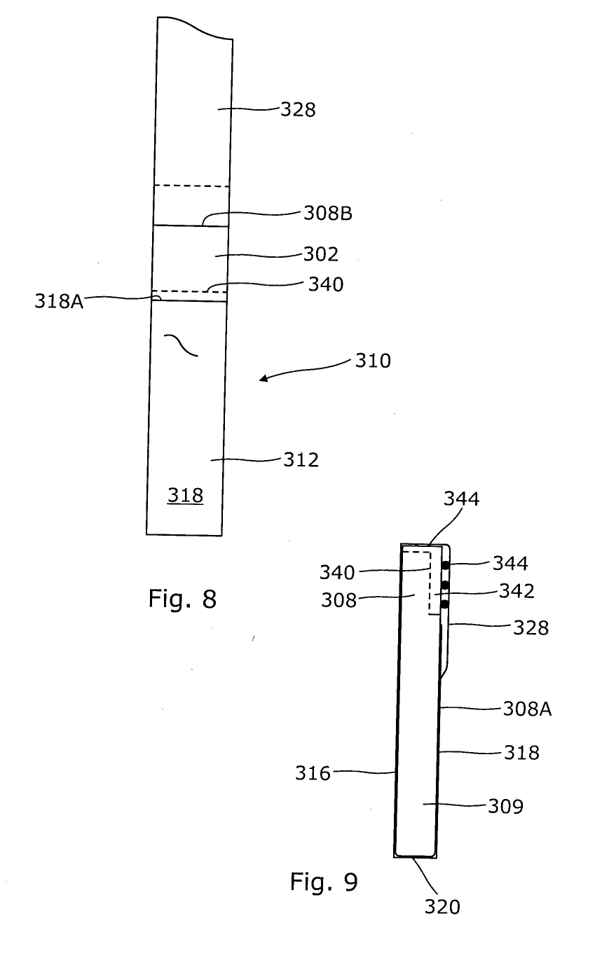

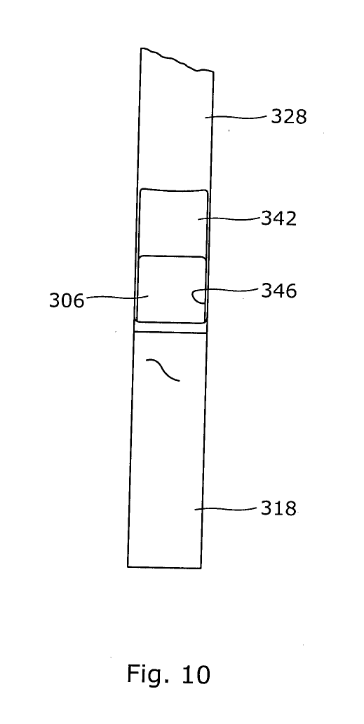

A third embodiment of a packaging assembly 310 will now be described with reference to FIGS. 8 to 10.

The packaging assembly 310 in accordance with the third embodiment is similar in construction and operation to that of the second embodiment 210. Accordingly, only those aspects of the packaging assembly 310 of the third embodiment which differ from packaging assembly 210 of the second embodiment will be described in detail. In all other respects the reader should refer to the description of the packaging assembly 210 of the second embodiment above.

The packaging assembly 310 differs from the packaging assembly 210 in that it contains only a single stack 302 of elongate individually wrapped gum sticks 306. The carton 312 is dimensioned accordingly but is otherwise constructed in the same manner as the carton 212 in the second embodiment as described above.

The other significant difference is that unlike the previous embodiments, the wrapper 308 in the third embodiment fully encloses the stack gum sticks 306 in the stack 302 initially. A line or pattern of weakness 340 is provided in the wrapper in the region that projects beyond the upper end 318A of the front wall 318 to define an openable dispensing region 342. The wrapper in the openable dispensing region 342 is bonded to the flap 328 in its closed position so that on first movement of the flap 328 to the open, dispensing position, the openable dispensing region 342 remains attached to the flap and the wrapper is torn along the line of weakness to reveal an opening 346 in the wrapper through which an end region of at least a forward most one of the gum sticks is exposed so that it can be engaged to move the gum stick out of the wrapper 308 and hence out of the carton through the dispensing open 326. The wrapper in the openable dispensing region 342 can be bonded to the carton flap 328 by any suitable means such as adhesive 344, which may be a cold seal adhesive, or by welding.

In the embodiment as shown in FIGS. 8 to 10, the line of weakness 340 extends laterally (as shown) fully across a front wall 308A of the wrapper and partially across both side walls at a position that aligns just above the upper edge 318A of the front wall of the carton. The line of weakness 340 then extends upwardly, generally parallel to the front wall to a position just below the upper end wall 308B of the wrapper where it again turns to extend rearwardly across the remainder of both side walls to the rear wall of the wrapper. With this arrangement, the entire front wall of the wrapper is removed above the line of weakness together the upper end wall 308B and portions of the side walls adjacent the front and end walls when the package is opened. This exposes the entire front face in an upper end region of the forward most gum stick 306 in the stack and makes it easy for a user to move the gum stick upwardly out of the wrapper and the carton. However, the removable dispensing region 342 need not always take this configuration. For example, the line of weakness 340 need not necessarily extend into the side walls of the wrapper, provided that a sufficiently large region of the wrapper at the exposed upper end the stack that projects beyond the front wall 318 of the carton 312 is removed to enable a user to engage the forward most stick 306 in the stack and move it out of the wrapper and the carton.

As with the previous embodiments, after one or more gum sticks 306 have been dispensed, the flap 228 can be folded over the exposed ends of the gum sticks 306 and inserted in the slot 330 to retain the remaining gum sticks in the carton.

The packaging assembly 310 in accordance with the third embodiment can be manufactured in a similar method to that of the first and second embodiments. The gum sticks 306 are first individually wrapped and then arranged in a stack 302 and the outer wrapper 308 applied about the stack to form a packet assembly. The packet assembly is positioned on a blank prior to the blank being folded to define the interior volume. Typically, the packet assembly will be positioned on and adhered to a rear wall panel of the blank and the blank folded about the packet assemblies to form the end and front walls 320, 318. At least the front wall 318 is also adhered to the outer wrappers 208 of the packet assemblies but the end wall may also be adhered for additional security. The flap 328 is also adhered to the wrapper within the removable dispensing region 342 as it is positioned about the stack and held in the closed position. The blank may be similar to the blank 214 in FIG. 11 but suitably dimensioned for use with a single wrapped stack of gum sticks 306.

The concept of providing an openable dispensing region 342 defined by a line of weakness in the wrapper and which is adhered to a carton flap 328 is not limited to embodiments having a single stack 302 of gum sticks but can equally be applied in embodiments having two or more individually wrapped stacks 302 of gum sticks, such as in the second embodiment 210. In this case, the carton may have a single closure flap that is adhered to the openable dispensing regions 342 of each of the wrappers so that they are all opened simultaneously on first movement of the flap to the dispensing position. Alternatively, the carton may have a separate closure flap or flap portion for each stack, so that each stack can be opened independently of the others by lifting its respective flap or flap portion. For example, in a packaging assembly having two individually wrapped stacks of gum sticks, similar to the second embodiment, the carton flap may be divided into two flap portions by means of a line of weakness. Each flap portion is affixed to the openable dispensing region 342 of a respective one of the stacks. The consumer can chose to open only one of the stacks at a time by lifting the appropriate flap portion. Furthermore, the concept of providing an openable dispensing region 342 in the wrapper can also be adapted for use with cartons such as that disclosed in the first embodiment 10 with a flip top lid or indeed any other type of movable closure. In this case, the, or each, openable dispensing region 342 is bonded to the flip top lid or other movable closure member so that the wrapper is torn on first movement of the lid or other closure member to the dispensing position to enable the gum sticks to be dispensed.

Whilst the above description relates to packaging for gum sticks, it can be adapted to provide packaging for other elongate products and especially other elongate comestible products.

The above embodiments are described by way of example only. Many variations are possible without departing from the scope thereof. For example, the number of gum sticks 106, 206, 306 in each stack can be selected as desired. The number of packet assemblies 109, 209, 309 could also be varied from only a single packet assembly up to three, four or more. The package assembly 10, 210, 310 could also be provided with an outer wrapper or film that encases the carton and which is removed by a consumer on first opening of the package assembly.

1. A packaging assembly comprising a carton having opposed rear and front walls and an end wall interconnecting the rear and front walls at one end to define an interior volume, the carton defining an opening between the front and rear walls at a second end opposite from said one end through which products may be dispensed and having a closure member movable between a closed position in which it closes the opening to retain products in the interior volume and a product dispensing position in which products may be dispensed through the opening, the packaging assembly comprising at least one stack of elongate comestible products located within the interior volume, the products in the at least one stack being positioned one behind another in a direction from the front wall to the rear wall, the at least one stack being at least partially enclosed about one end by means of a flexible outer wrapper, the wrapper being affixed to the carton.

2. The packaging assembly as claimed in claim 1, wherein the wrapper only partially encloses the stack of elongate comestible products, an end region of at least a forward most one of the products in the at least one stack projecting from the wrapper and engageable, at least when the closure is in the product dispensing position, to permit the product to be moved out of the wrapper and the carton.

3. The packaging assembly as claimed in claim 1, wherein the wrapper fully encloses the stack of elongate comestible products, the wrapper having at least one line of weakness that defines an openable dispensing region at one end of the stack, the wrapper in the openable dispensing region being affixed to the closure so that on first movement of the closure to the product dispensing position, the wrapper is torn along the at least one line of weakness to expose an end region of at least a forward most one of the products in the at least one stack, the packaging assembly being configured such that once opened, said exposed end region is enageable, at least when the closure is in the product dispensing position, to permit the product to be moved out of the wrapper and the carton.

4. The packaging assembly as claimed in claim 2, wherein at least one aperture is defined in the front wall through which the end region of at least a forward most one of the products in the at least one stack can be engaged to move the product out of the of the wrapper and the carton.

5. The packaging assembly as claimed in claim 2, wherein the front wall is shorter than the rear wall, the at least one stack projecting beyond an upper edge of the front wall such that the end region of at least a forward most product in the at least one stack is engageable to permit the product to be moved out of the wrapper and the carton when the closure member is in the dispensing position.

6. The packaging assembly as claimed in claim 1, wherein, the closure member comprises a flap pivotally connected with the rear wall, the flap extending about an end of the products and overlapping at least part of the front wall when in the closed position, the packaging assembly having a fastening arrangement for releasable securing the flap in the closed position.

7. The packaging assembly as claimed in claim 1, wherein the closure member comprises a flip-top lid pivotally connected with the rear wall, the packaging assembly having a fastening arrangement for releasable securing the lid in the closed position.

8. The packaging assembly as claimed in claim 7, wherein the fastening arrangement comprises co-operating formations on the lid and the front wall for releasably holding the lid in the closed position.

9. The packaging assembly as claimed in claim 1, wherein the packaging assembly comprises at least two stacks of elongate comestible products arranged side-by-side within the interior volume, each stack of products being at least partially enclosed by means of a flexible outer wrapper.

10. The packaging assembly as claimed in claim 1, wherein the packaging assembly consists of a single stack of elongate comestible products within the interior volume, said stack of products being at least partially enclosed by means of a flexible outer wrapper.

11. The packaging assembly as claimed in claim 1, wherein the, or each, flexible outer wrapper is adhered to the carton.

12. The packaging assembly as claimed in claim 2, wherein the, or each, flexible outer wrapper encases its respective stack of elongate comestible products about one end, the other end of the products in the stack projecting beyond the wrapper.

13. The packaging assembly as claimed in claim 1, wherein the carton is formed from a blank of foldable material.

14. The packaging assembly as claimed in claim 1, wherein the carton consists of the rear wall, the front wall, the end wall and the closure member only, the front and rear walls both being affixed to the, or each, flexible outer wrapper.

15. The packaging assembly as claimed in claim 1, wherein the carton also comprises a pair of opposed side walls extending between the rear and front walls to define the interior volume.

16. The packaging assembly as claimed in claim 1, wherein the elongate comestible products are all individually wrapped.

17. The packaging assembly as claimed in claim 1, wherein the elongate comestible products are gum sticks.

18. A method of manufacturing a packaging assembly as claimed in claim 1, the method comprising: producing a blank of foldable material for forming the carton, at least partially encasing at least one stack of elongate comestible products in a flexible outer wrapper, positioning the at least one stack on the blank, affixing the, or each, flexible outer wrapper to the blank, and folding the blank about the stack to form the carton and securing in position.

19. The method as claimed in claim 18, in which the step of affixing the, or each, flexible outer wrapper to the blank is carried out before the carton is fully formed.

20. The method as claimed in claim 19, in which the step of affixing the, or each, flexible outer wrapper to the blank is carried out before the blank is folded about the stack to define the interior volume.

21. The method as claimed in claim 20, in which the, or each, flexible outer wrapper is affixed to a first part of the blank before the blank is folded about the at least one stack to define the interior volume and is affixed to a further part of the blank during the process of folding the blank.
